(19) United States
(12) Patent Application Publication
(10) Pub. No.: US 2011/0249474 A1
(43) Pub. Date: Oct. 13, 2011

(54) METHOD AND APPARATUS FOR POWER CONVERSION USING AN INTERLEAVED FLYBACK CONVERTER WITH ALTERNATING MASTER AND SLAVE BRANCHES

(76) Inventor: Yuhao Luo, San Jose, CA (US)

(21) Appl. No.: 13/079,340

(22) Filed: Apr. 4, 2011

Related U.S. Application Data
(60) Provisional application No. 61/342,293, filed on Apr. 12, 2010.

(51) Int. Cl. H02M 3/335

(52) U.S. Cl. 363/21.12

(57) ABSTRACT

Embodiments of the present invention generally relate to power conversion and, more particularly, to a method and apparatus for performing power conversion using an interleaved flyback converter with alternating master and slave branches. The apparatus comprises a plurality of parallel connected flyback circuits; a controller is coupled to the switches within the flyback circuits to turn-on and turn-off the plurality of flyback circuits; a current monitor element at the output connected to the controller; a voltage monitor element connected to the controller; based on monitored current and voltage the controller controls the operation of flyback circuit; slave circuit only turn-on when the power is higher than a threshold value; the master and slave circuits are alternating to even the usage of the circuits.

### CROSS REFERENCE TO RELATED PATENT APPLICATIONS

This patent application claims priority to U.S. Provisional Patent Application No. 61/342,293 to Luo filed on Apr. 12, 2010, which is herein incorporated by reference in its entirety.

### BACKGROUND OF THE INVENTION

1. Field of the Invention

Embodiments of the present invention generally relate to power conversion and, more particularly, to a method and apparatus for performing power conversion using an interleaved flyback converter with alternating master and slave branches.

2. Description of the Related Art

A number of pulse width modulated DC-to-DC converter topologies are available in the power electronics for performing DC-to-DC conversion. Such converters employ a flyback converter topology which is used in instances that require electrical isolation, voltage boost-up, and high efficiency. A flyback converter topology consists of a transformer, a switch (usually a MOSFET transistor) and a diode. Typically, the switch is in series with the primary winding of the transformer and the secondary winding the transformer is serially coupled through the diode to a load. By switching a current through the primary coil, the DC voltage applied across the primary coil and switch is “boosted” to a higher voltage level at the load.

In order to double the output power available from a typical DC-to-DC converter, two flyback converters may be connected in parallel and operated in an interleaved fashion. Each of the flyback converters forms a “branch” of the overall DC-to-DC conversion process. Each branch is activated independently and in an interleaved manner. To facilitate a balanced operation such that the power is accurately converted from the input DC to the DC applied to the load, each branch must be “matched”.

However, with the activation of 2 branches, the power consumption increases and degrades the efficiency. One method to reduce power consumption is using the 2 branches as master and slave branch. The master branch is always on, while the slave branch is off when the power is below a threshold level. However, this method may cause the different operation in master and slave branch. This difference causes the mismatch and related issues, such as temperature difference, different device degradation, etc. Also as the master branch is always on, reliability and lifetime of the converter is constricted by the master branch.

Therefore, there is a need in the art for a method and apparatus to improve power conversion efficiency and reliability for interleaved flyback converter.

### SUMMARY OF THE INVENTION

Embodiments of the present invention generally relate to a method and apparatus for converting DC input power to DC output power, specifically to an interleaved flyback converter with alternating master and slave branches. The apparatus comprises a plurality of parallel connected flyback circuits. A controller is coupled to the switches within the flyback circuits to turn-on and turn-off the plurality of flyback circuits, so that slave circuit only turn-on when the power is higher than a threshold value, while the master circuit is on at any power value. Meanwhile, the master and slave circuit are alternating to even the usage of the circuits, so that the performance and reliability of the converter is improved.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic diagram of a interleave flyback DC-to-DC converter in accordance with embodiments of the present invention

FIG. 2 is a block diagram of the controller in a interleave flyback DC-to-DC converter in accordance with embodiments of the present invention

FIG. 3 is a timing diagram of the signals within the DC-to-DC converter using prior art interleave flyback circuit

FIG. 4 is a timing diagram of the signals within the DC-to-DC converter using master and slave interleave flyback circuit in accordance with embodiments of the present invention

FIG. 5 is a timing diagram within the DC-to-DC converter representing the alternating master and slave interleave flyback circuit in accordance with one embodiment of the invention

### DETAILED DESCRIPTION

The topology provided by the subject invention solves many of the problems associated with, and has many advantages over, the prior art topologies. The present invention device is unique when compared with other known devices and solutions because the present invention provides: an interleaved flyback converter with alternating master and slave branches. The apparatus comprises a plurality of parallel connected flyback circuits; a controller is coupled to the switches within the flyback circuits to turn-on and turn-off the plurality of flyback circuits; a current monitor element at the output connected to the controller; a voltage monitor element connected to the controller; based on monitored current and voltage the controller controls the operation of flyback circuit; slave circuit only turn-on when the power is higher than a threshold value; the master and slave circuits are alternating to even the usage of the circuits.

While the present invention is hereafter described in terms of an interleaved flyback converter, one skilled in the art will recognize that the power element can possess multiple functionalities without departing from the spirit of the invention. Specific embodiments of the present invention are hereafter described in detail with reference to the accompanying Figures. Like elements in the various Figures are identified by like reference numerals for consistency. Although the invention has been described and illustrated with a certain degree of particularity, it is understood that the present disclosure has been made only by way of example and that numerous changes in the combination and arrangement of parts can be resorted to by those skilled in the art without departing from the spirit and scope of the invention.

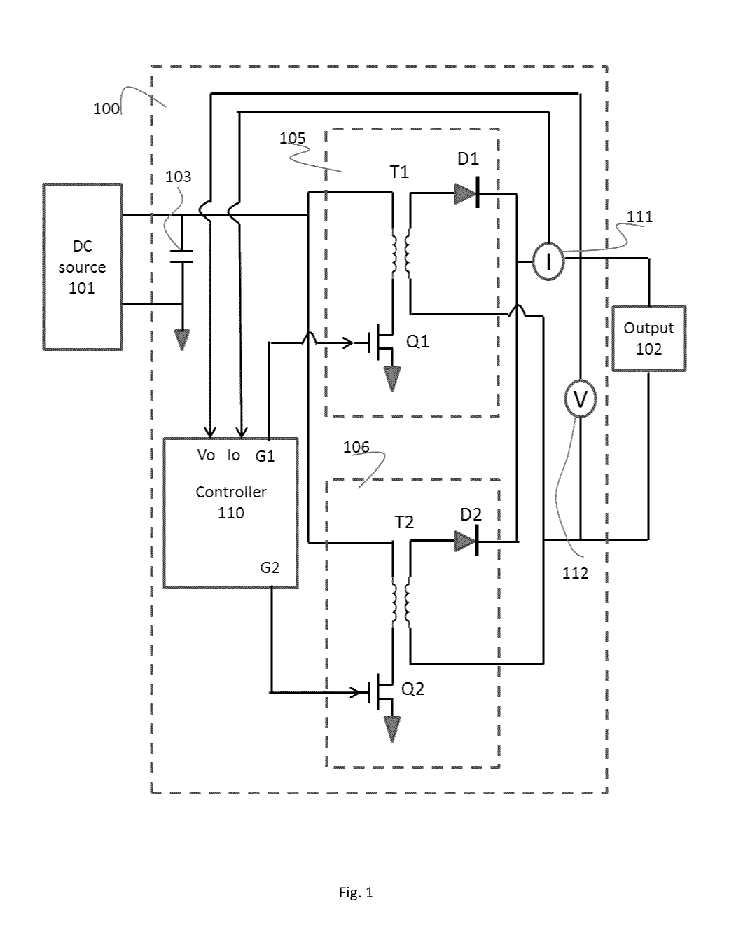

FIG. 1 is a schematic diagram of an interleaved flyback DC-to-DC converter 100 according to embodiments of the present invention. This converter can function in a variety of power conversion systems, including solar inverter, and other systems requiring DC to-DC conversion. This diagram only illustrates an example out of DC-to-DC converter configurations.

The DC-to-DC converter 100 converts DC voltage from a DC source 101 to a DC voltage at output 102. The DC source 101 may be photo voltaic (PV) panels or some other source of DC power. The output 102 may be connected to a device that uses the DC power, including a DC-to-AC converter. The DC-to-DC converter 100 (an interleaved flyback converter) comprises an input capacitor 103 that is used for storing energy to facilitate an accurate DC-to-DC conversion process and a plurality of flyback circuits, such as first flyback circuit 105 and a second flyback circuit 106. The flyback circuits are arranged in a parallel manner with respect to the input DC source 101 and output 102.

The flyback circuits 105 and 106 are identical and termed “branch”. The flyback circuit 105 comprises a transformer T1 and a switch Q1 and a diode D1. The primary coil of the transformer T1 is coupled in series to the switch Q1. The secondary coil of the transformer T is coupled through diode D1 to output 102. In one embodiment, the switch Q1 uses a field effect transistor (FET). The drain of the transistor Q1 is coupled to ground as well as to one terminal of the DC source 101, and the source of the transistor Q1 is coupled to the primary coil of the transformer T1. The capacitor 103 is coupled across the input to the flyback circuit 105 such that one terminal of the capacitor 103 is coupled to one terminal of the primary coil of the transistor T1, and the second terminal of the capacitor 103 is coupled to the drain of the transistor Q1. The gate of the transistor is coupled to the controller 110 at the output of G1. The flyback circuit 106 comprises a transformer T2 and a switch Q2 and a diode. The input of the flyback circuit 106 is coupled in parallel with the input of the flyback circuit 105. The output of the flyback circuit 106 is coupled in parallel with the output of the flyback circuit 105.

At the output 102, there is a current monitoring element 111 and a voltage monitoring element 112. The current and voltage monitored is coupled to the controller 110 at Io and Vo to control the turn-on and turn-off of each branches (circuits 105, 106) of the DC-to-DC converter and to achieve the alternating of master and slave branches.

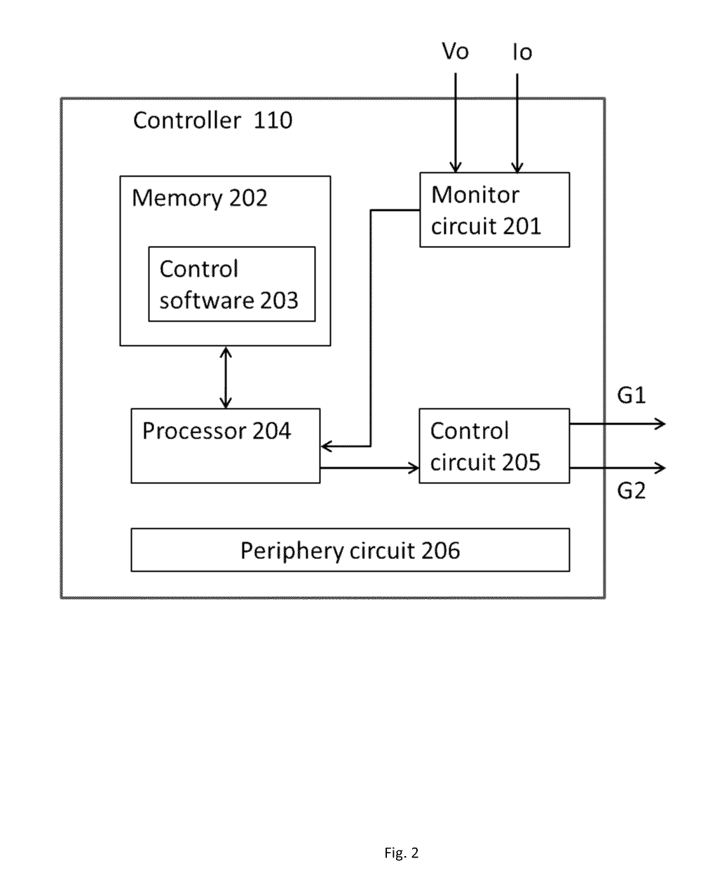

FIG. 2 is a block diagram of the controller in a interleave flyback DC-to-DC converter in accordance with embodiments of the present invention. The controller 112 may comprise monitor circuit 201; memory 202, which may comprise control software 203; processor 204; control circuit 205, and periphery circuit 206. The signals Io and Vo from the monitor elements 111,112 are converted from analog signals to digital signals using ADC circuit in monitor circuit 201. Memory modules may consist of any type of memory device, such as random-access memory, read-only memory, flash memory chips, processor registers, caches, hard disks, readable or writable optical or tape storage, capacitors, other circuitry, or any other type of device known to those of skill in the art. The memory 202 stores the control software 203 that is executed by the processor 204 to send signal to control circuit 205 to control the operation of the interleaved flyback circuits 105 and 106. The processor may be a form of CPU, MCU, FGPA, or an application specific integrated circuit (ASIC). The periphery circuits 206 may comprise well known circuits for the controller 112, including power supplies, clock circuits, bus circuits, IO circuits and the like.

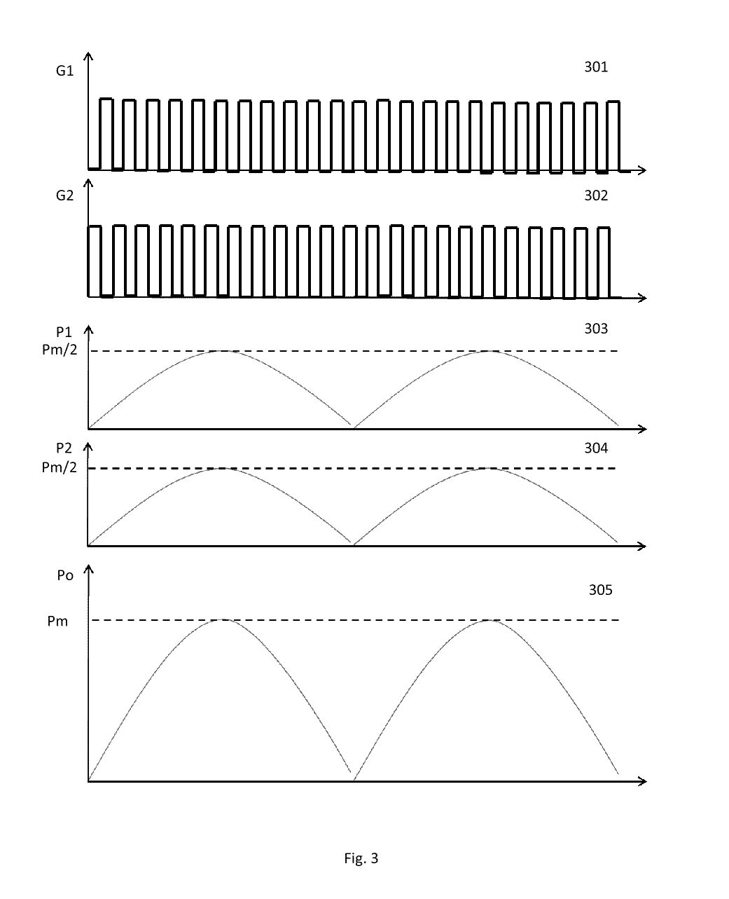

FIG. 3 depicts the relative timing of signals used within the DC-to-DC converter 100 of FIG. 1 according to prior art. Graphs 301 and 302 depict the signal G1 and G2, which are the voltage on the gate of the transistors Q1 and Q2. Q1 and Q2 turn on when the G1 and G2 are at high voltage. Graphs 301 and 302 depict the activation and deactivation times of each branch (each flyback circuit 105,106) within the DC-to-DC converter 100. Each branch is operated on an interleaved manner such that one branch is activated while the other branch is deactivated and vice versa. The graph 303 shows the power envelope P1 at the output of branch 105, while the graph 304 shows the power envelope P2 at the output of branch 106. The graph 303 and 304 are identical in the prior art. The graph 305 is the composite power envelope Po, which is the sum of P1 and P2. Po is also equal to the multiple of Io and Vo, monitored by element 111 and 112. The peak value of Po is Pm, while the peak value of P1 and P2 is Pm/2. By using a plurality of branches that are switched in an interleaved manner, current in continuously coupled to the load and the amount of ripple in the output DC voltage is significantly reduced. In addition, the use of parallel connected flyback circuits enables the output power to be substantially increased to the load, e.g., for two circuits, the available power is doubled.

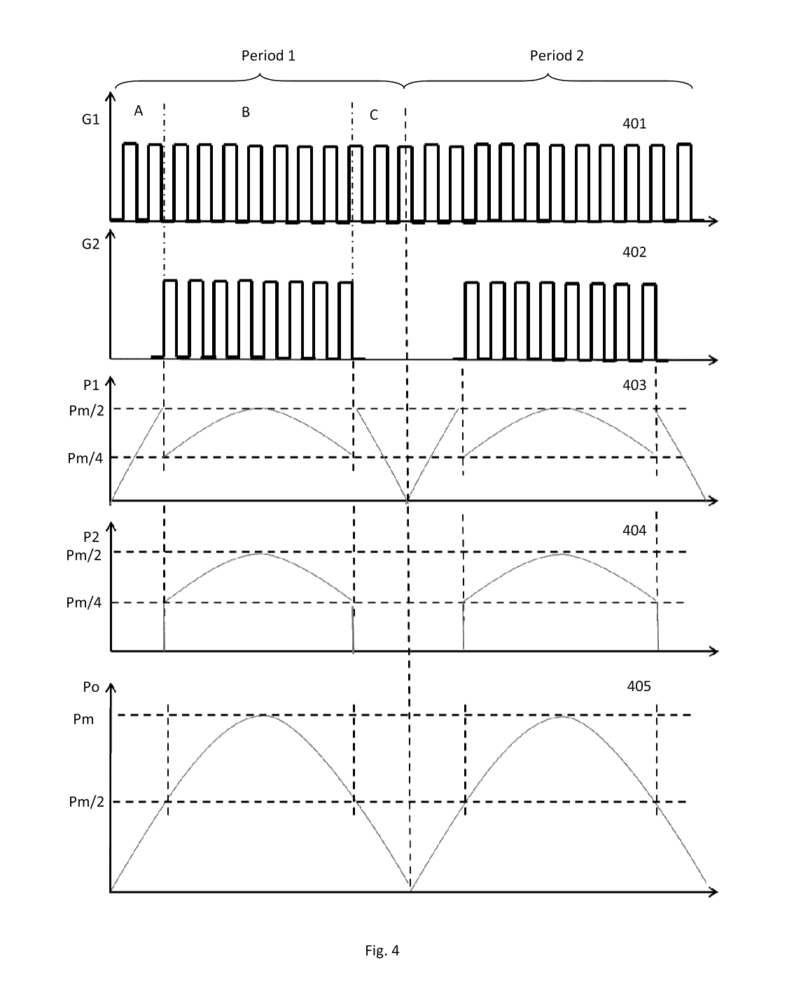

One embodiment of the present invention is to assign branches into different levels, such as master and slave when there are 2 branches. The master branch is always operating, but the slave would be off (termed “sleep”) when the power is below a threshold level. When the output power is below the threshold value, only the master branch is operating. Compared with the situation that both branches are operating with even power, this invention has less power consumption as less devices are operating. FIG. 4 depicts the relative timing of signals used within the DC-to-DC converter 100 of FIG. 1 according to one embodiment of the present invention. Graphs 401 and 402 depict the voltage of the signal G1 and G2, which are on the gate of the transistors Q1 and Q2. Q1 and Q2 turn on when the G1 and G2 are at high voltage. The graph 403 shows the power envelope P1 at the output of branch 105. The graph 404 shows the power envelope P2 at the output of branch 106. The graph 405 shows the power envelope P2 at the output of converter 100, which is the composite of P1 and P2. Even the graph 405 is the same as graph 305, the graph 403 and 404 are different from the graph 303 and 304. All period are the same, as shown by period 1 and period 2. Each period has 3 regions A, B and C. In region A, Po increase from 0 to Pm/2. In region B, Po increase from Pm/2 to Pm and then decrease to Pm/2. In region C, Po decreases from Pm/2 to 0. In region A and C, only master branch 105 is operating, while slave branch 106 is sleep. As result, P2 is 0. P1 is between 0 and Pm/2, instead of Pm/4 as shown in graph 303. In region B, both master and slave branches operate evenly and so P1 and P2 are identical and the same as shown in graph 303 and 304.

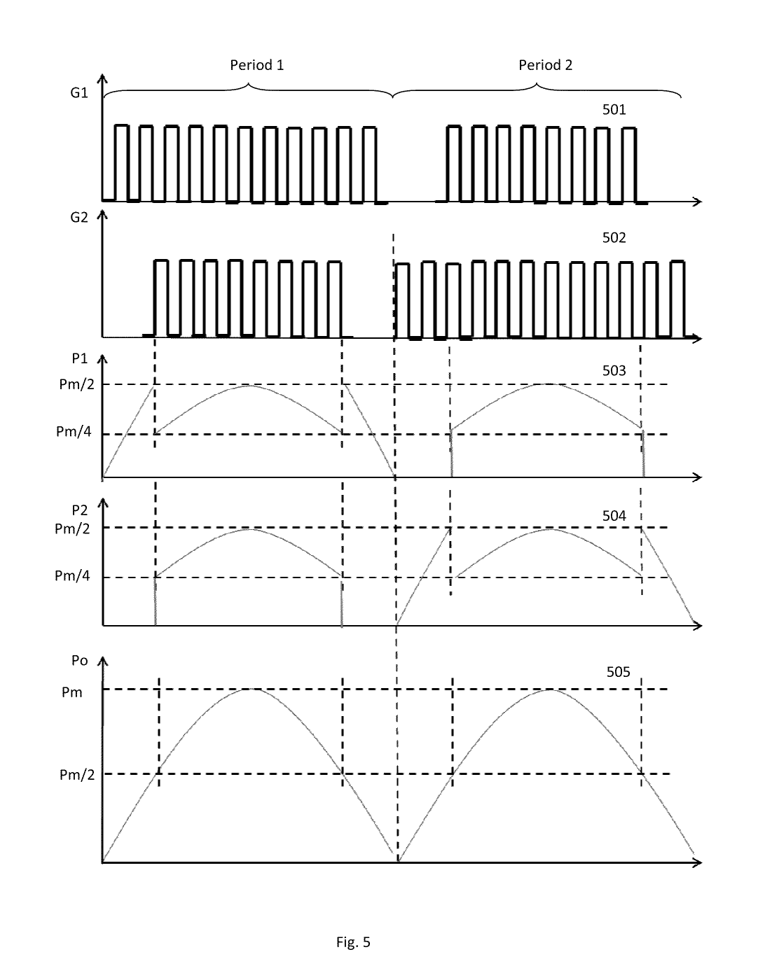

Another embodiment of the invention is the alternating of branches. When the master branch is a fixed branch, as the master branch is always operating, while the slave branch sleeps in some time, the 2 branches have mismatches, such as operating temperature, device stress, etc. Different operation in master and slave branch results in different performance and device degradation, which causes all mismatch related problems. Also the lifetime of the converter would be limited by the master branch as it had more stress. With the alternating of the branches, meaning the 2 branches work as the master branch alternatively, the 2 branches have same operating period. Each branch has less operating time than the case of fixed master branch. As shown in FIG. 5, Graphs 501 and 502 depict the voltage of the signal G1 and G2, which are on the gate of the transistors Q1 and Q2. The period 1 and period 2 are different. In the period 1, branch 105 works as the master branch and branch 106 is the slave branch. As described above, branch 105 is always operating, while branch 106 is sleep when the power is below the threshold value (Pm/4 in this example). In the period 2, branch 106 works as the master branch and branch 105 is the slave branch. The graph 503 shows the power envelope P1 at the output of branch 105. The graph 504 shows the power envelope P2 at the output of branch 106. The graph 505 shows the power envelope Po at the output of converter 100, which is the composite of P1 and P2. In period 1, graph 503,504 and 505 are the same as graph 403,404,405. However, in period 2, as the master and slave branches is alternating, graph 503 is the same as 404, while 504 is the same as 403. In one embodiment, in every period the master and slave branches alternates. The control can be performed by cross-zero of Po, meaning whenever Po value reaches 0, the master branches changes to slave branch, and slave branch changes to master branch.

In the example above, the alternating period is the period of output power. In another embodiment, the period can be any other time settings, such as multiple periods, 1 second, 1 minute, 1 hour, 1 day, 1 week, 1 month, or likes.

An example of converter with 2 flyback circuits (branches) operating in parallel is discussed above. The invention can be expanded to any number (termed N) of flyback circuits coupled in parallel in the similar way. For peak output power at Pm, the peak output power of each ranch is Pm/N. The threshold voltage for alternating control may be set as Pth=Pm/(N*N). The number of the turn-on branches is the value of 1 plus the divide integer between Po and Pth. When Po is between 0 and Pth, 1 branch is turn-on, which is termed as master branch. When Po is between Pth and 2Pth, 2 branches are turn-on, which is termed as master and 1^{st} slave 1 branch. When Po is between i*Pth and (i+1)*Pth, master branch and 1^{st} to i^{th} slave branches are turn-on. When Po is between (N−1)*Pth to Pm, all branches are turn-on, with master branch and 1^{st} to N−1^{th} slave branches.

Similar to the example above, the master and slave branches are alternating. For example, one embodiment can be s following: the master becomes slave 1, slave 1 becomes slave 2, slave i becomes slave i+1, and slave N−1 becomes the master.

In example above, the output power Po is used to control branches. As output voltage Vo is a constant DC voltage, another embodiment is only using monitored output current Io to control branches.

What is claimed is:

1. An interleaved flyback converter comprising: alternating master and slave branches.

2. The apparatus of claim 1, further comprising a plurality of parallel connected flyback circuits.

3. The apparatus of claim 2, further comprising a controller that is coupled to at least two switches within the plurality of flyback circuits.

4. The apparatus of claim 3, wherein the switches turn-on and turn-off the plurality of flyback circuits.

5. The apparatus of claim 4, wherein the slave branch is a slave circuit that switches on when the power is higher than a threshold value.

6. The apparatus of claim 5, wherein the master branch is a master circuit that is on at power value different than the threshold value.

7. The apparatus of claim 6, wherein the master and slave circuit are alternating to even a usage of the master and slave circuits.

8. The apparatus of claim 1, wherein current and voltage are monitored by a circuit.

9. The apparatus of claim 8, further comprising a controller to control an on and an off state of each of the branches.

10. The apparatus of claim 1, wherein the apparatus is utilized as a DC-to-DC converter.

11. The apparatus of claim 1, wherein the branches are operated on an interleaved manner such that one branch is activated while the other branch is deactivated.

12. The apparatus of claim 1, wherein the interleaved flyback converter is a DC-to-DC converter that converts DC voltage from a DC source to a DC voltage at an output.

13. The apparatus of claim 12, wherein the DC source is a photovoltaic (PV) panel.

14. The apparatus of claim 12, wherein the output is connected to a DC-to-AC converter.

15. The apparatus of claim 1, further comprising: an input capacitor for storing energy.

16. An interleaved flyback converter that has alternating master and slave branches for a solar cell comprising;
a plurality of parallel connected flyback circuits;
a controller that is coupled to at least two switches within the plurality of flyback circuits, wherein the switches turn-on and turn-off the plurality of flyback circuits and wherein the slave branch is a slave circuit that turns-on when the power is higher than a threshold value, and wherein the master branch is a master circuit that is switched on at a predetermined value being different than the threshold value.

17. The converter of claim 16, wherein the master and slave circuit are alternating to even a usage of the master and slave circuits.

18. The converter of claim 17, wherein current and voltage are monitored by a circuit and further comprising a controller to control an on and off state of each of the branches.

19. A method comprising:
providing a first flyback circuit that comprises a transformer, a switch, and a diode with an input of the first flyback circuit being is coupled in parallel with an input of a second flyback circuit;
monitoring current and voltage;
providing a controller being connected to the first and the second flyback circuit; and
controlling of the first and second flyback circuits to achieve the alternating of master and slave branches.

20. The method of claim 19, further comprising providing power conversion by controlling the first and second flyback circuits.
